(19) United States
(12) Patent Application Publication
(10) Pub. No.: US 2025/0185834 A1
(43) Pub. Date: Jun. 12, 2025

(54) Electric Food Preparation Appliance

(71) Applicant: SEB S.A., Ecully (FR)

(72) Inventors: Philippe Dumoux, Ecully Cedex (FR); Romain Turpin, Ecully Cedex (FR); Guillaume Prieto, Marsannay Le Bois (FR); Johan Petitallot, Ecully Cedex (FR); Frédéric Denis Seurat, Bretigny (FR)

(73) Assignee: SEB S.A., Ecully (FR)

(21) Appl. No.: 18/976,988

(22) Filed: Dec. 11, 2024

(30) Foreign Application Priority Data
Dec. 11, 2023 (FR) 2313952

(51) Int. Cl. A47J 27/00; A47J 27/08

(52) U.S. Cl. CPC A47J 27/002; A47J 27/0804

(57) ABSTRACT

A food preparation appliance including a main lid, and a removable inner lid. The main lid can be moved between an open position and a closed position. The removable inner lid is designed to be coupled to the main lid. The food preparation appliance is designed to provide at least one first cooking mode in which the inner lid is coupled to the main lid and at least one second cooking mode in which the inner lid is removed from the main lid. The food preparation appliance comprises a closure mechanism that can be moved between retracted position and a deployed position. The retracted position is used in the first cooking mode, and the deployed position is used in the second cooking mode where the closure mechanism is designed to close off a gap left open when the inner lid is removed from the main lid.

### TECHNICAL FIELD OF THE INVENTION

The present invention in general relates to a food preparation appliance, and in particular, the invention relates to a food preparation appliance designed to provide at least one pressure cooking mode and at least one convection cooking mode.

### STATE OF THE ART

In the prior art of food preparation appliances, appliances are known to provide several cooking modes, in particular least one pressure cooking mode and at least one convection cooking mode. Providing these two cooking modes on the same appliance typically requires the use of a removable inner lid to leakproof the cooking space (the cooking vessel) of the food preparation appliance in the pressure cooking mode, and removing this inner lid makes it possible to use the convection cooking mode in order to allow the necessary hot air flow to circulate. On the other hand, once the inner lid has been removed, a gap is formed between the main lid and the vessel or the housing. Thus, such a food preparation appliance may leak steam or hot air between the main lid and the housing or the vessel, particularly around the handles of the cooking vessel. Such leaks can make the handles too hot for the user to grasp comfortably and/or safely during or shortly after cooking.

### DISCLOSURE OF THE INVENTION

One purpose of the present invention is to address the aforementioned drawbacks of the prior art and in particular, firstly, to provide a food preparation appliance that is designed to provide at least one pressure cooking mode and at least one convection cooking mode and that does not present any risk of discomfort and/or burns during its operation and/or use.

To this end, a first aspect of the invention relates to a food preparation appliance comprising at least:
a housing, comprising a compartment for receiving a cooking vessel and defining a cooking space,
a main lid, which can be moved between an open position allowing access to the cooking space and a closed position preventing access to the cooking space,
a removable inner lid designed to couple with the main lid so that, when the main lid is in the closed position, it bears in a leakproof manner against an edge of the housing and/or of the cooking vessel,
the food preparation appliance being designed to provide at least one first cooking mode in which the inner lid is coupled to the main lid, and at least one second cooking mode in which the inner lid is removed from the main lid,
characterized in that the food preparation appliance comprises a means of closure, which can be moved between:
a retracted position, used in the first cooking mode, to enable the inner lid to be mounted,
a deployed position, used in the second cooking mode and in which the means of closure are designed to at least partially close off a gap between the cooking space and the outside of the food preparation appliance, left free when the inner lid is removed from the main lid.

According to the above embodiment, the food preparation appliance comprises means of closure which can occupy a deployed position (or a closure position) when the inner lid is absent. By thus allowing the means of closure to at least partially take the place of the inner lid, the means of closure form a screen or barrier to hot air or steam flows at the gap formed between the main lid and the vessel or the housing after the inner lid has been removed, to prevent leakage between the main lid and the cooking vessel or housing. In other words, the means of closure locally limit fluid exchanges between the outside and the cooking space via the gap formed between the main lid and the vessel or the housing, regardless of the presence of the inner lid. As a result, the outer edge of the main lid (typically any handles on the housing or the cooking vessel) is not exposed to any hot air or steam leakage even in the convection cooking mode, such that the user can handle the appliance and/or handles comfortably and safely.

The food preparation appliance can also have one or more of the following features, taken alone or in combination.

According to one embodiment, the gap is arranged between the main lid on the one hand, and the housing and/or the cooking vessel on the other hand. The gap in question is the one which, in the majority of food preparation appliances, opens out around the edge of the main lid and therefore onto the handles on the housing of the appliance, and/or onto the vessel handles. The means of closure therefore close off a surface around the edge of the main lid, between the main lid and the cooking vessel or the housing, and keep steam from venting from the cooking vessel toward the housing handles and/or toward the vessel handles. The temperature of the handles therefore remains moderate compared to a temperature that could present a risk of burns on contact.

According to one embodiment, the main lid comprises means of ventilation and means of heating, and the second cooking mode comprises at least one convection cooking step. This second cooking mode typically creates a flow of hot gases (hot air and steam from the food to be cooked) by generating a heat flow directed onto the food by the means of heating coupled to the means of ventilation. In the second cooking mode, which uses a recirculation and/or venting system for the flow of hot gases (hot air and steam), the heating and means of ventilation need to be able to communicate with the cooking vessel. The inner lid is therefore incompatible with this second cooking mode and must be removed from the food preparation appliance. Deploying the means of closure before the start of this convection cooking mode provides a screen to limit leakage of the hot gas flow from the aforementioned air and steam flows toward the handles. The means of closure can also protect the main lid, its inner structure (typically delineated by interconnected walls), and, for example, the means of ventilation (typically comprising a drive motor) and the means of heating, from infiltration of gas flows.

According to one embodiment, the food preparation appliance comprises at least one vent arranged to vent a gas flow generated in the cooking space in the second cooking mode. The gap closed by the means of closure thus does not prevent the venting of the gas flow in the cooking vessel, which is directed toward the vent which has been specially designed, arranged and dedicated to venting hot cooking gases (steam, hot air).

According to one embodiment, at least one vent is arranged on the main lid and is rendered inoperative by the inner lid in the first cooking mode. In the first cooking mode, the cooking space is leakproofed, and the vent is no longer used to vent hot gases directly from the cooking space. On the other hand, the vent can be occupied and/or used by a means of pressure control (such as a pressure control valve) typically fitted on the inner lid.

According to one embodiment, the first cooking mode comprises at least one pressure cooking step. Pressure cooking is made possible by leakproofing the cooking space, a constraint that is typically incompatible with other cooking modes, such as convection and/or steam cooking. For this reason, the inner lid is (removably) added to the main lid in the pressure cooking mode, to sufficiently seal off the cooking space from the outside environment for pressure cooking. The inner lid, which forms a screen above the cooking space, can also be used to protect the main lid, the means of heating and/or the means of ventilation in certain particularly messy cooking modes.

According to one embodiment, the food preparation appliance comprises a means of automatic gravitational return arranged to move the means of closure by gravity at least from the retracted position to the deployed position, so as to easily automate the movement of the means of closure. Operations carried out on the inner lid automatically adapt the position of the means of closure: the user does not have to manipulate the means of closure when changing cooking modes. In particular, to move the means of closure from the deployed position to the retracted position, the user (when installing the inner lid) simply pushes on the means of closure with the inner lid such that the inner lid takes the place of the means of closure around the edge of the main lid. In the second cooking mode (with the inner lid removed), the means of closure, under their own weight, move from the retracted position to the deployed position when the main lid is closed.

According to one embodiment, the means of automatic return comprise a means of elastic return designed to move the means of closure at least from the retracted position to the deployed position. These can be one or more springs, compressed between the main lid and the means of closure when the means of closure are in a retracted position, and designed to drive or push the means of closure into the deployed position by relaxing in the absence of an inner lid.

According to one embodiment, the food preparation appliance comprises means of manual return designed to enable a user to move the means of closure. This can be a lever and/or a knob and/or a handle, connected to the sealing ring and with a control interface positioned outside the main lid, such that a user can cause the means of closure to move, at least toward the deployed position.

According to one embodiment, the means of automatic return are means of gravitational return. Thus, in a preferred embodiment, the means of closure move solely under the force of their own weight to move from their retracted position to their deployed position.

According to one embodiment, the means of closure comprise a sealing ring. Such a ring can extend around the entire edge (i.e., 360°) of the cooking space, and/or of the cooking vessel, and/or of the housing and/or of the main lid.

According to one embodiment, the deployed means of closure touch, or come into contact with, the cooking vessel and/or the housing. According to one embodiment, when deployed, the means of closure leave a gap or clearance of less than 1 mm, preferably less than 0.5 mm, between the cooking vessel and/or the housing and the means of closure. Of course, according to these features, the main lid is in the closed position.

According to one embodiment, the sealing ring comprises a deformable gasket, to ensure at least a partial seal with respect to the outside of the cooking vessel. A deformable lip, a closed gasket or a hollow gasket can be provided.

According to one embodiment, the sealing ring is designed to fit snugly around the housing and/or the cooking vessel, particularly in the second cooking mode, in order to minimize the size and/or number of openings between the main lid and the cooking vessel, which could create leaks during cooking.

According to one embodiment, the means of closure comprise means of guiding on the main lid. The means of guiding ensure that the movable means of closure follow a specific trajectory as they move. The means of guiding also ensure free movement of the means of closure, with no hindrance or friction against the main lid frame that could interfere with the movement of the means of closure.

According to one embodiment, the means of guiding comprise a plurality of slides, preferably three slides. The means of closure thus move along a straight trajectory relative to the main lid.

According to one embodiment, the food preparation appliance comprises means for detecting the deployed position of the means of closure, to allow for the second cooking mode. Thus, the risk of burns caused by hot gas leaks is minimized.

According to one embodiment, the food preparation appliance comprises a control unit connected to the means of detection and designed to control the first cooking mode and/or the second cooking mode.

According to one embodiment, the inner lid comprises a pressure control valve, and/or a means of safety on opening/closing featuring a pressure gauge system such as an Aroma pin, and/or a safety valve.

According to one embodiment, the food preparation appliance is electric.

### DESCRIPTION OF THE FIGURES

Other features and advantages of the present invention will become more apparent from the following detailed description of an embodiment of the invention, provided by way of non-limiting example and illustrated in the appended figures, in which:

FIG. 1 shows a general view of a food preparation appliance comprising a housing and a main lid in a closed position to prevent access to a cooking space of the food preparation appliance, the preparation appliance being designed to provide at least one pressure cooking mode and at least one convection cooking mode;

FIG. 2 shows a view from underneath of the main lid in FIG. 1 to show means of closure designed to fit over a work vessel or the housing in a convection cooking mode;

FIG. 3 shows a detail of a cross-sectional view of the food preparation appliance in FIG. 1, with the means of closure in a deployed position to allow for the convection cooking mode;

FIG. 4 shows a detail of a cross-sectional view of the food preparation appliance shown in FIG. 1, with the means of closure in a retracted position due to the installation of an inner lid to allow for a cooking mode with a pressure cooking step;

FIG. 5 shows a view of a frame of the main lid with the means of closure in the retracted position;

FIG. 6 shows the view in FIG. 4 to show an embodiment according to a first alternative with respect to means for returning the means of closure, the means of closure being in the retracted position;

FIG. 7 shows the food preparation appliance in FIG. 6, with the means of closure in the deployed position;

FIG. 8 shows an alternative embodiment of the means of closure shown in FIG. 3 or 4, in the deployed position;

FIG. 9 shows the means of closure in FIG. 8, in the retracted position.

### DETAILED DESCRIPTION OF EMBODIMENT(S)

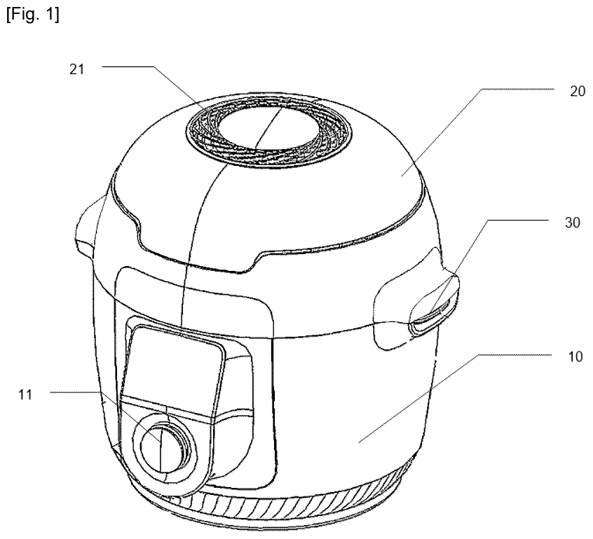

FIG. 1 shows an electric food preparation appliance comprising a housing 10 and a main lid 20 designed to close the housing 10. The food preparation appliance is designed to operate several cooking modes, including at least one pressure cooking mode and at least one convection cooking mode.

To this end, the food preparation appliance comprises a selection interface 11 to enable the user to select the cooking mode of their choice. The selection interface 11 can be one or more buttons and/or a tactile interface, and/or a thumbwheel.

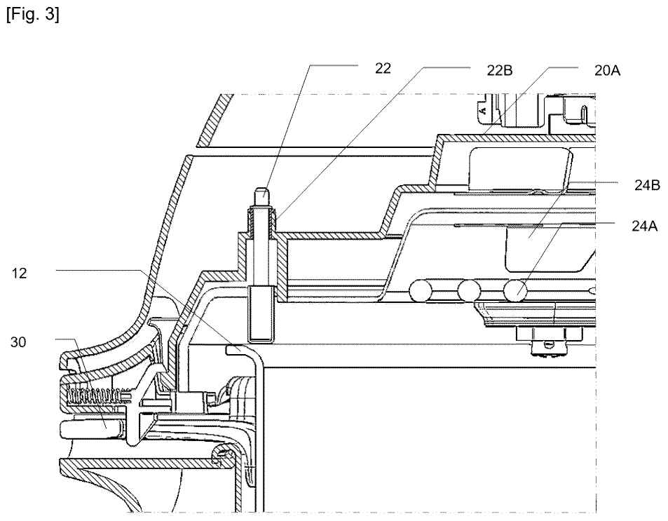

Two handles 30 (seen between the housing 10 and the main lid 20) are attached to a cooking vessel 12 (seen from FIG. 3) received in a compartment of the housing 10 and intended to receive the food to be cooked and to create a cooking space by being placed in the housing 10 during cooking. A vent 21 on the main lid 20 enables cooking vapors and/or hot air flows generated during certain cooking operations to be vented.

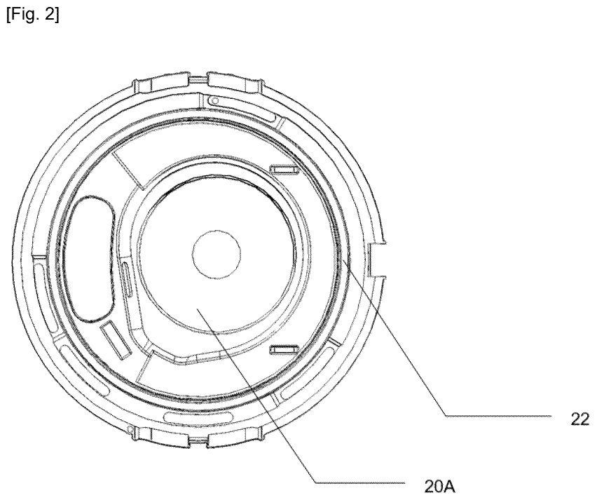

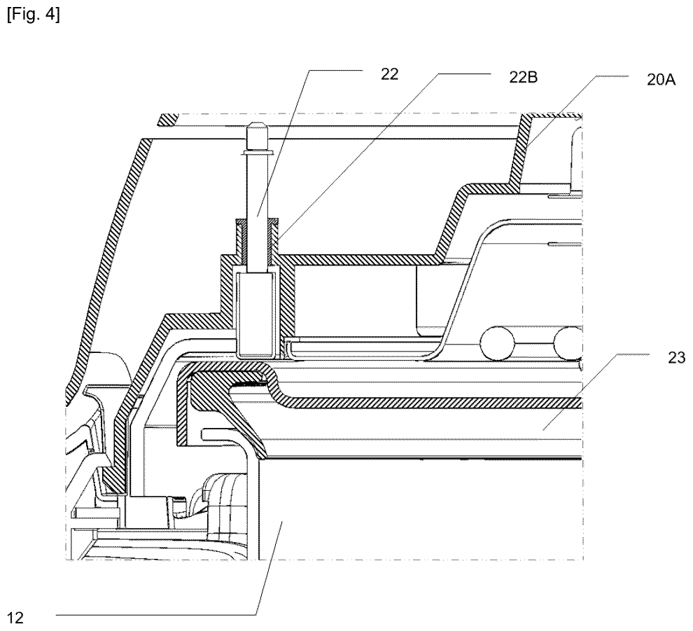

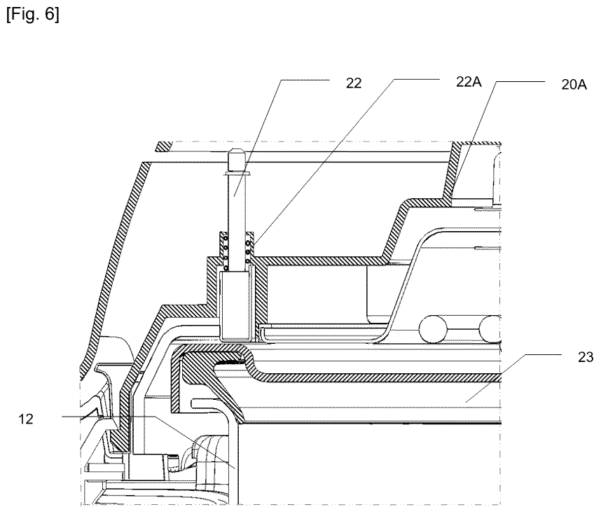

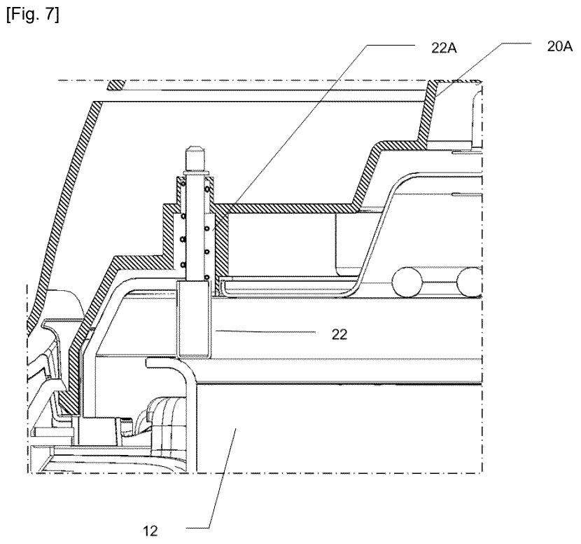

FIG. 2 shows a view from underneath of the main lid 20 and in particular a view from underneath of a frame 20A of the main lid 20. Means of closure 22 are arranged in the main lid 20 and can be moved between a retracted position (shown in FIGS. 4 and 6) and a deployed position (shown in FIGS. 3 and 7). The means of closure 22 are designed to change position automatically, and move according to a slide connection relative to the frame 20A. In this embodiment, the means of closure 22 are in the form of a sealing ring fitted around the edge of the main lid 20, and are designed to fit snugly around or in contact with the cooking vessel and/or the housing 10 in certain circumstances, such as in the convection cooking mode. It should be noted that the sealing ring fitted around the edge extends 360°.

FIG. 3 shows a cross-section of the food preparation appliance at one of the slide connections of the means of closure 22. To enable cooking that requires the generation and circulation of a hot gas flow, for example for a steam or convection cooking mode, means of heating 24A and means of ventilation 24B are arranged directly opposite the cooking vessel 12 and the food to be cooked.

The means of closure 22 are in their deployed position, closing off a gap allowing this hot gas to flow toward the outside, particularly toward the handles 30, and/or toward an inner area of the main lid 20 where there are control elements that are sensitive to potential vapor leaks, such as a circuit board or a drive motor for the means of ventilation.

In the configuration shown in FIG. 3, namely in the convection cooking mode, the gas flows are directed toward the vent 21 (shown in FIG. 1) so as to exit the cooking space, and there is no hot gas flow between the main lid 20 on the one hand and the cooking vessel 12 or the housing 10 on the other hand. The temperature of the handles during or shortly after cooking thus presents no risk of burns to the user. In this preferred embodiment, the means of closure 22 move from their retracted position to their deployed position due to the weight of the means of closure 22 itself. Means of guiding, in the form of a slide bearing 22B, guide the means of closure 22 to form the aforementioned slide connection. A slight gap between the means of closure 22 and the cooking vessel 12 is shown in FIG. 3, but contact can be expected due to the weight of the means of closure.

FIG. 4 shows a cross-section of the food preparation appliance at one of the slide connections of the means of closure 22. The means of closure 22 are in their retracted position. An inner lid 23 is coupled to the main lid 20 and arranged between the means of closure 22 on one side and the cooking vessel 12 on the other side, such that the inner lid 23 can fit over the edge of the cooking vessel 12 to adjust to its shape and ensure a sealed cooking space delineated by the inner lid 23 and the cooking vessel 12 when it is closed by the main lid 20. This embodiment ensures a sufficient pressure build-up in the cooking vessel 12 as the temperature rises for pressure cooking.

When the inner lid 23 is mounted on the main lid 20, it is understood that the means of closure 22 are pushed into this retracted position and are housed in a recess in the frame 20A that is deep enough to keep one end of the means of closure 22 from protruding from the recess and interfering with the installation of the inner lid 23 or the sealing of the cooking space.

The inner lid 23 is removable and designed to be handled by a user, and its presence or absence corresponds to a different position of the means of closure 22. The inner lid 23 is then temporarily attached during pressure cooking, and keeps the means of closure 22 in their retracted position.

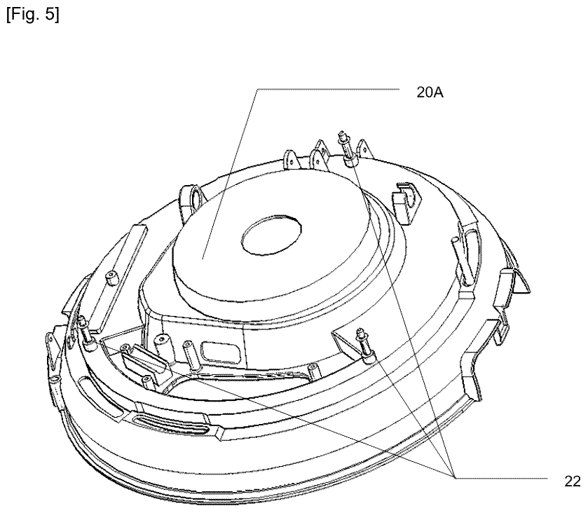

FIG. 5 shows the frame 20A of the main lid 20, seen from above and forming an inner structure of the main lid 20. The main lid 22 is in the same configuration as in FIG. 4, and the means of closure 22 are in their retracted position. Rods on the means of closure 22 have been pushed in and protrude (in this retracted position) from the upper surface of the frame 20A, freeing up space under the frame 20A for the inner lid 23.

FIG. 6 shows an embodiment according to a first alternative, in the same plane as in FIG. 4, with the means of closure 22 in the retracted position, the food preparation appliance comprising means of elastic return 22A as an alternative to gravitational return. In fact, alternative means of elastic return 22A such as springs (shown in FIGS. 6 and 7) automatically cause the means of closure 22 to move from their retracted position to their deployed position.

FIG. 7 shows the cross-section in FIG. 6 with the means of closure in their deployed position.

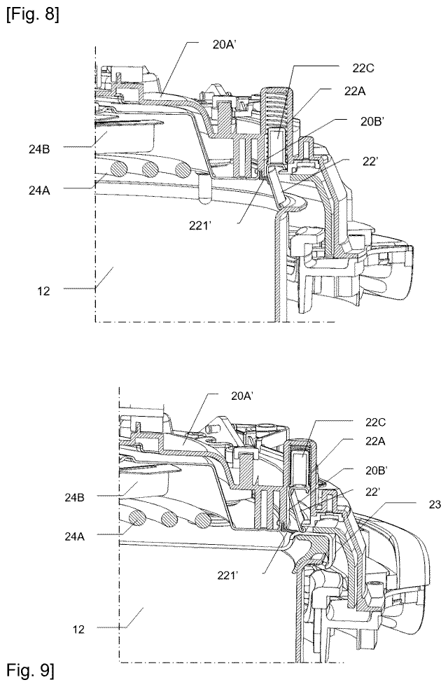

FIG. 8 shows a cross-sectional view of a food preparation appliance comprising an alternative embodiment of the means of closure shown in FIG. 3 or 4. In the alternative embodiment in FIG. 8, the means of closure 22′ are formed by a frustoconical sealing ring. The frustoconical sealing ring can be formed by a metal strip curved at both ends, as shown in FIG. 8.

The frustoconical sealing ring is slidably mounted on a cylindrical inner wall 20B′ of the frame 20A′ of the lid, and a return assembly comprising means of return 22A (compression springs) and pins 22C pushes the frustoconical sealing ring to bear on the cooking vessel 12, in particular on its upper rim, at the junction radius with the side wall of the cooking vessel 12.

A secondary gasket 221′ can be fitted between the frame 20A′ and the frustoconical sealing ring to improve the sealing against hot gases or cooking vapors. With such a secondary gasket 221′, the inner structure of the lid 20 is protected from exposure to hot gases or cooking vapors, thereby improving the durability of the food preparation appliance. Such a secondary gasket can also be foreseen in the embodiment in FIG. 3, 4, 6 or 7.

Thus, in the configuration in FIG. 8, a convection and/or direct radiation cooking mode is possible, with the participation of the means of heating 24A and/or of the means of ventilation 24B mounted on the frame 20A′ of the lid 20. In the deployed position, the frustoconical sealing ring limits the flow of hot gases between the housing and the lid.

FIG. 9 shows the frustoconical sealing ring in its retracted position, due to the installation of an inner lid 23 coupled to the main lid 20 and arranged between the means of closure 22′ on one side and the cooking vessel 12 on the other side. Thus, a pressure cooking mode is possible. When the inner lid is mounted, the frustoconical sealing ring is pressed against the frame 20A′ to occupy the retracted position shown in FIG. 9, thereby pushing back the pins 22C and compressing the means of return 22A.

It should be noted that when the inner lid 23 is subsequently disassembled, the force exerted by means of return 22A on the frustoconical sealing ring (and therefore on the inner lid 23) makes it easier to extract the inner lid 23.

### INDUSTRIAL APPLICATION

A food preparation appliance according to the present invention, and the manufacture thereof, are suitable for industrial application.

It will be understood that various modifications and/or improvements that are obvious for the person skilled in the art may be made to the different embodiments of the invention described in this description without departing from the scope of the invention.

In particular, it should be noted that the means of closure can be a simple screen, namely a movable wall in the main lid. The means of closure can be removed and/or disassembled with no tools to enable cleaning. The means of closure can be in several separate, interconnected or temporarily interconnected parts. Any type of movement can be foreseen instead of the translational movement described: pivoting, tilting, with a lever, etc. It should be noted that there can be a plurality of means of return for the means of closure, and a plurality of combinations of these means of return for returning the means of closure.

As an alternative to means of closure that can be moved relative to the rest of the lid, means of closure can also be provided that involve lowering all the elements of the lid to create a seal on the cooking vessel. In other words, once the inner lid has been removed, the means of closure (the remainder of the main lid) drop down to come into contact with the cooking vessel (its upper rim, for example) to shield off hot gases and limit or even prevent their flow between the main lid and the housing.

Of course, the invention is in no way limited to the embodiment described and illustrated, which has only been provided by way of example. Changes can still be made, particularly with regard to the constitution of the various elements or by substituting technical equivalents, without departing from the scope of protection of the invention.

1. A food preparation appliance comprising:
a housing, comprising a compartment configured to receive a cooking vessel and defining a cooking space,
a main lid, which is configured to move between an open position allowing access to the cooking space and a closed position preventing access to the cooking space,
a removable inner lid configured to couple with the main lid so that, when the main lid is in the closed position, the main lid bears against an edge of the housing and/or of the cooking vessel in a leakproof manner,
wherein the food preparation appliance is configured to provide a first cooking mode in which the inner lid is coupled to the main lid, and a second cooking mode in which the inner lid is separated from the main lid,
wherein the food preparation appliance comprises a closure mechanism configured to move between:
a retracted position, used in the first cooking mode, to enable the inner lid to be mounted to the main lid, and
a deployed position, used in the second cooking mode, in which the closure mechanism is configured to at least partially close off a gap between the cooking space and an outside space, left open when the inner lid is removed from the main lid.

2. The food preparation appliance according to claim 1, wherein the gap is between the main lid and the housing and/or the cooking vessel.

3. The food preparation appliance according to claim 1, wherein the main lid comprises a ventilation mechanism and a heating mechanism, and the second cooking mode comprises at least one convection cooking step.

4. The food preparation appliance according to claim 1, further comprising a vent configured to vent a gas flow generated in the cooking space when the appliance is in the second cooking mode.

5. The food preparation appliance according to claim 4, wherein the vent is disposed in the main lid and is rendered inoperative by the inner lid when the appliance is in the first cooking mode.

6. The food preparation appliance according to claim 1, wherein the first cooking mode further comprises at least one pressure cooking step.

7. The food preparation appliance according to claim 1, further comprising a return mechanism configured to move the closure mechanism from the retracted position to the deployed position by gravity.

8. The food preparation appliance according to claim 1, further comprising an elastic return element configured to move the closure mechanism from the retracted position to the deployed position.

9. The food preparation appliance according to claim 1, further comprising a manual return mechanism configured to enable a user to move the closure mechanism.

10. The food preparation appliance according to claim 1, wherein the closure mechanism comprises a sealing ring.

11. The food preparation appliance according to claim 10, wherein the sealing ring comprises a deformable gasket.

12. The food preparation appliance according to claim 10, wherein the sealing ring is configured to fit snugly around the housing and/or the cooking vessel.

13. The food preparation appliance according to claim 1, wherein the closure mechanism comprises a guiding apparatus.

14. The food preparation appliance according to claim 13, wherein the guiding apparatus comprises a plurality of slides.

15. The food preparation appliance according to claim 1, further comprising an indicator mechanism configured for detecting the deployed position of the closure mechanism.
